(19) United States
(12) Patent Application Publication
(10) Pub. No.: US 2014/0098022 A1
(43) Pub. Date: Apr. 10, 2014

(54) JOYSTICK FOR A COMPUTER KEYBOARD

(71) Applicant: MINI STICK, LLC, Wildwood, MO (US)

(72) Inventors: James T. Bellistri, Wildwood, MO (US); Robert Edward Georgie, Elsberry, MO (US)

(73) Assignee: MINI STICK, LLC, Wildwood, MO (US)

(21) Appl. No.: 13/644,638

(22) Filed: Oct. 4, 2012

(51) Int. Cl. G06F 3/02; G06F 3/033

(52) U.S. Cl. 345/161

(57) ABSTRACT

A keyboard joystick comprises a base having key actuating areas associated with the underside of the base. A control stick is mounted to the base to enable a user to actuate the arrow keys of a computer keyboard in conjunction with an associated computer game, for example.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

This disclosure relates to a joystick designed to allow the user to manipulate the arrow keys of a computer keyboard in a fluid like manner so as to facilitate improved control of those keys. While the disclosure is specifically directed to computer keyboards, those skilled in the art will recognize the wider applicability of the inventive concept disclosed hereinafter.

Computer games are and continue to be popular diversions for computer use. The games generally have various skill levels which players try to obtain. Often separate joysticks can be purchased for operating the game. However, it is common to provide a default control of the game through the use of the keyboard arrow keys. Separate joysticks tend to be relatively expensive and are not easily mobile, for example when traveling with a corresponding laptop device. In those and other similar situations, use of the arrow keys previously has been the only practical way for game control. For many users the hand/eye coordination required to rapidly manipulate the arrow keys is quite difficult and as such achieving the level of control (or scores) desired can prove difficult. We have developed a low cost alternative to the conventional separate joystick that takes advantage on the keyboard arrow keys. By encompassing all arrow keys simultaneously control is markedly improved as manipulation is facilitated by merely applying pressure in the direction of the desired key. The design simulates the conventional separate joystick in that a user no longer has to depress the individual arrow keys during game operation.

### BRIEF SUMMARY OF THE INVENTION

One of the features of the present disclosure is to provide a temporary mounting of a control device to the keyboard of an associated computer.

Another feature of the disclosure is to provide a device that allows its easy removal from a computer keyboard and returns the keyboard to normal operation upon such removal.

Still another object of the disclosure is to provide a removable joystick having an ergonomic design to provide better control of the affected keys.

Another feature of the disclosure is a joystick design which provides better travel or movement with the exertion of less force by the user, thereby enabling the device to remain in position on the keyboard.

Another feature of the disclosure is a construction and design which will accommodate a variety of keyboard designs.

Other features of the present disclosure illustratively described herein will be in part apparent and in part pointed out hereinafter.

In accordance with this disclosure, generally stated, a joystick is provided which is removably mounted on a computer keyboard. In one preferred embodiment the joystick includes a base, the base having a center section and a plurality of extensions projecting outwardly from the center section arranged such that each of the extensions have at least one key engaging or activating surface associated with it for activating selective keys of the associated keyboard. A handle is mounted to the base, the handle having a first end for engagement with a user and a second end adapted to transmit force to respective keys of the keyboard when the handle is moved in any of the north, south, east or west directions in response to the commands of a user.

The foregoing and other objects, features, and advantages of the disclosure as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a view in perspective, partly broken away, of one illustrative embodiment of a keyboard joystick attachment mounted to the keyboard of an associated computer showing our new design;

FIG. 2 is a view in perspective of the joystick shown in FIG. 1;

FIG. 3 is a bottom view in perspective of the joystick shown in FIG. 1;

FIG. 4 is an exploded view of the embodiment shown in FIG. 1; and

FIG. 5 is a bottom plan view in perspective of a second illustrative embodiment of the joystick shown in FIG. 1.

Corresponding reference numerals indicate corresponding parts throughout the several figures of the drawings.

### DESCRIPTION OF THE PREFERRED EMBODIMENT

The following detailed description illustrates the present disclosure by way of example and not by way of limitation. The description clearly enables one skilled in the art to make and use the development which we believe to be new and unobvious, describes several embodiments, adaptations, variations, alternatives, and uses of the system, including what is presently believed to be the best mode of carrying out the inventive principles described in this specification.

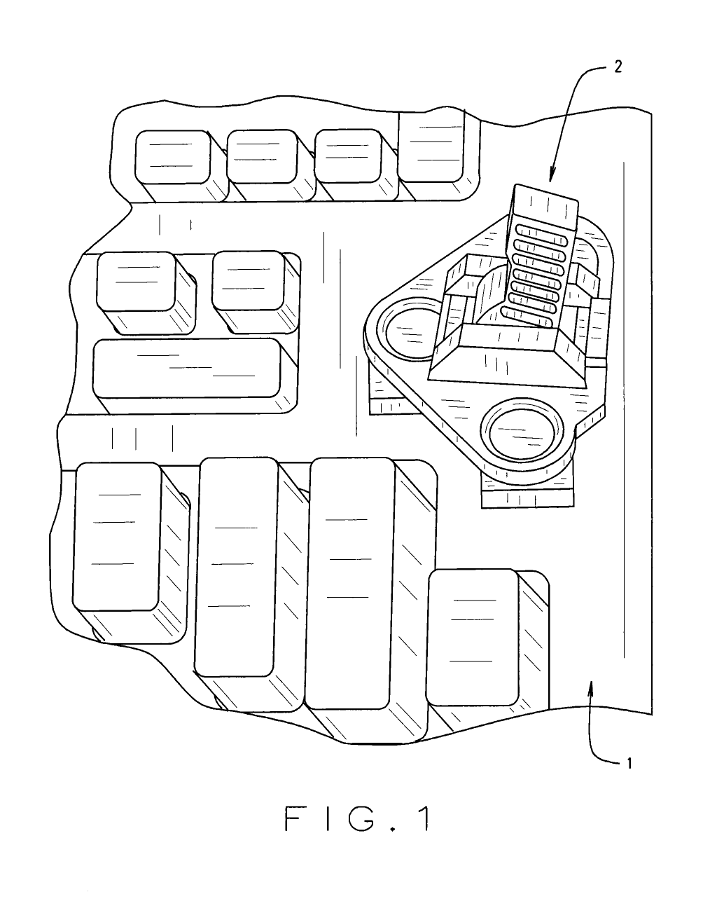

Referring now to FIG. 1, reference numeral 1 indicates a computer keyboard having one illustrative embodiment of the computer joystick 2 associated with it. The keyboard 1 can assume any number of configurations, and a variety of configurations are known in the art, including both full size and reduced sized keyboards, for example. In general, regardless of size configuration, all of the keyboards 1 are provided with a cluster of arrow keys associated with the keyboard. The joystick 2 is designed to be removably mounted to the keyboard 1 in a manner so as to enable the joystick 2 to actuate the arrow keys at the direction of a user.

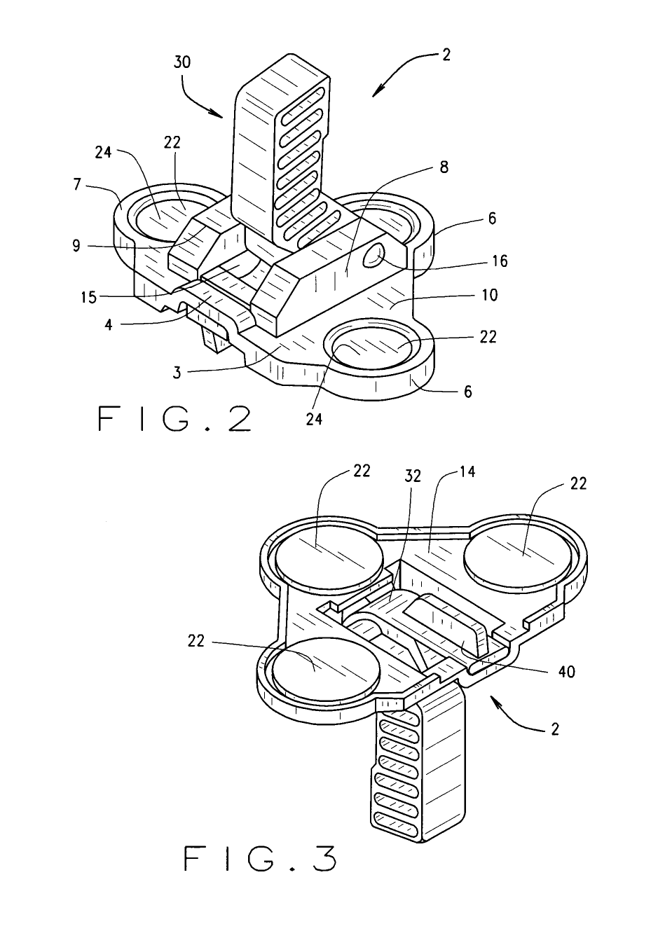

Referring now to FIGS. 2, 3 and 4, the preferred embodiment of the joystick 2 includes a base 3 having a handle or control stick 30 attached or mounted to the base 3 as later described. Base 3 may assume a variety of configurations. In the environment shown, the base 3 generally includes a central section 4 having a plurality of arms 5, 6, and 7 respectively extending outwardly from it. The central section 4 also has a pair of space, parallel projections 8 and 9 respectively extending upwardly from an upper side 10 of the base 3. The projections 8 and 9 defined a central passageway 15 between the upper side 10 and a bottom side 14 of the central section 4.

As will be appreciated by those skilled in the art, the particular design configuration of the base 3 may vary in other embodiments of the base 3. In the preferred embodiment shown, the design attempts to provide the projections 8 and 9 and central section 4 in a manner to conserve material used in the construction of the base 3 in general and the central section 4 in particular. The other consideration in defining the preferred design is that the base 3 and the arms 5, 6, and 7 each have at least one convex pad 22 extending downwardly or outwardly from the bottom side 14 to enable individual ones of the arms 6, 7, and 8 to actuate one of the arrow keys of associated computer keyboard 1 through the arrow key operative contact with the pads 22.

Each of the projections 8 and 9 have an aligned opening 16 formed in them, which is used to attach the handle 30 of the joystick 2 to the base 3 as described hereinafter. The projections 8 and 9 are generally centrally located along the base 3, and each of the arms 5, 6, and 7 are positioned outboard of the projections. Each of the arms 5, 6, and 7 has an indentation 24 and on the side 10 of the base 3. The indentations 24 in turn define the respective actuator pads 22 on the bottom side 14 of the base 3.

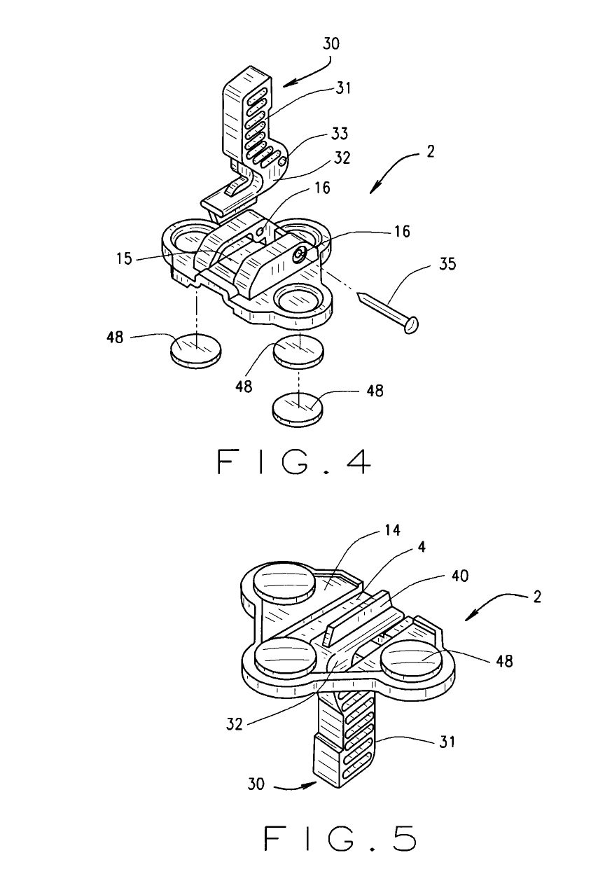

As can be best seen in FIG. 4, The handle 30 of the joystick 2 includes a handle part 31, and a mounting part 32. The handle part 31 is conventional, and any of a variety of handle designs may be used in other embodiments of the device, if desired.

The mounting part 32 has an opening 33 extending through it, which aligns with the openings 16 in the projections 8 and 9 in the mounted position of the handle 30. The handle 30 is attached to the respective projections 8 and 9 by the insertion of a brass decorative finishing nail or brad 35 which is inserted through the openings 16 and 33 to mount the handle 30 to the base 3. Other attachment methods will be apparent to those skilled in the art.

As best seen in FIGS. 3 and 5, the mounting part 32 of the handle 30 further includes an actuator rib 40. The rib 40 preferably is integrally formed with the handle 30 and is sized to engage the down arrow key of the keyboard 1 when the joystick 2 is mounted on the computer keyboard 1. In that regard, the particular shape of the rib 40 may be adjusted to insure proper alignment of the rib with its associate key. As will be appreciated by those skilled in the art the pads 22 formed in the base 3 are positioned to operatively engage the left arrow, the up arrow, and a right arrow, while the bib 40 operatively engages the down arrow key when the joystick 2 is mounted on the keyboard 1.

If desired, additional mounting devices may be utilized to hold the joystick 2 in position on the board 1. In particular, we have found that hook and loop fastening devices 48 may be used in conjunction with the pads 22 to aid retention of the joystick 2 on the keyboard 1.

Operation of the joystick is simple in operation and use. The joystick is mounted on the keyboard 1 so that the pads 22 and the rib 40 ride or are operatively associated with the arrow keys on the keyboard 1. Thereafter, movement of the handle 30 forward, rearward, leftward, or rightward actuates the respective arrow keys of the keyboard 1. As indicated above, embodiments of the joystick 2 may employ hook and loop fasteners, or similar additional attachment methods to hold the joystick 2 to the keyboard 1. Merely by way of example, double sided tape, with or without foam backing, may be used, if desired.

Numerous variations, within the scope of the appended claims, will be apparent to those skilled in the art. Merely by way of example, and not of limitation, the silhouette of the base 3 and/or the handle 30 may vary in other embodiments of the joystick 2. The joystick 2 preferably is a plastic molded part, but other materials and construction methods may be utilized in other embodiments of the invention. Likewise, while the handle 30 is attached to the projections 8 and 9 through the use of a pin other attachment methods may be employed if desired. By way of example, the handle 30 may be releasable with respect to the base 3 to permit its removal for storage. Additionally, the joystick could be used on other keys like the “A”, “S”, “D” and “W” keys. These variations are merely illustrative.

Having thus described the invention, what is claimed and desired to be covered by Letters Patent is:

1. A joystick removably mounted on a computer keyboard, comprising:
a base, the base having a center section and a plurality of extensions projecting outwardly from the center section, each of the extensions having at least one computer keyboard key actuating surface associated with it for activating a key of the keyboard; and
a handle mounted to the base, the handle having a first end for engagement with a user and a second end having an extension associated with it for activating a key of the keyboard wherein the joystick is operatively associated with a plurality of keys of the keyboard.

2. The joystick of claim 1 wherein at least one of the key engaging surfaces of the base extensions are convex.

3. The joystick of clam 1 wherein the extension of the handle is an elongate rib.

4. The joystick of claim 2 wherein one half of a hook and loop fastener system is attached to at least one of the key engaging surfaces of the base.

5. The joystick of claim 1 wherein the handle is removably attached to the base.

6. The joystick of claim 1 wherein the joystick is frictionally mounted to the keyboard.

7. The joystick of claim 1 wherein the base and handle are injection molded plastic parts.

8. A joystick for use with the computer keyboard comprising:
a base, base including a center section having a plurality of projections extending outwardly from it, the center section adapted to receive a handle;
a handle mounted to the base, the handle including a rib sized and positioned to engage at least one key of a computer keyboard.

9. The joystick of claim 8 wherein the handle is removably mounted to the base.

10. The joystick of claim 9 wherein the center section further includes a plurality of arms sending outwardly from the center section, the arms including projections for acting to selectively actuate at least three keys of said keyboard.

11. The joystick of claim 10 wherein the base and handle are injection molded plastic parts.

12. The joystick of claim 11 wherein the handle is removably attached to the base.

13. The joystick of claim 12 wherein the joystick is removably mounted to the computer keyboard by a hook and loop fastener system such that one half of the hook and loop system is attached to at least one of the projections of the base

14. A joystick for use in conjunction with a second device having a plurality of adjacent keys, comprising:
a base, base including a center section having a plurality of projections extending outwardly from it, the center section adapted to receive a handle;
a handle mounted to the base, the handle including a rib sized and positioned to engage at least one key of the second device.
